(19) United States
(12) Patent Application Publication
(10) Pub. No.: US 2024/0330705 A1
(43) Pub. Date: Oct. 3, 2024

(54) Systems and Methods for Federated Learning of Machine-Learned Models with Sampled Softmax

(71) Applicant: Google LLC, Mountain View, CA (US)

(72) Inventors: Hang Qi, Mountain View, CA (US); Sagar Manohar Waghmare, New York, NY (US); Tomer Meron, Ra'anana (IL)

(21) Appl. No.: 18/579,089

(22) PCT Filed: Jul. 12, 2021
(86) PCT No.: PCT/US2021/041225

§ 371 Date: Jan. 12, 2024

(51) Int. Cl. G06N 3/098

(52) U.S. Cl. CPC G06N 3/098

(57) ABSTRACT

Example aspects of the present disclosure provide a novel, resource-efficient approach for learning image representation with federated learning, which can be referred to as federated sampled SoftMax. According to example aspects of the present disclosure, the federated learning clients sample a set of negative classes and optimize only the corresponding model parameters with respect to a sampled SoftMax objective that approximates the global full SoftMax objective. This approach significantly reduces the number of parameters transferred to and optimized by the client devices, while performing on par with the standard full SoftMax method. This creates a possibility for efficiently learning image representations on decentralized data with a large number of classes in a privacy preserving way.

### FIELD

The present disclosure relates generally to systems and methods for training machine-learned models. More particularly, the present disclosure relates to systems and methods for federated learning of machine-learned models with sampled SoftMax.

### BACKGROUND

The federated learning framework enables learning of a machine-learned model or across multiple decentralized devices (e.g., user devices such as smartphones) which each hold respective local data samples, typically without requiring exchange of the data samples between devices or to a central authority. This approach stands in contrast to traditional centralized machine learning techniques where all data samples are uploaded to a centralized authority, as well as to more classical decentralized approaches which assume that local data samples are identically distributed.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for federated learning of a machine-learned model with reduced computing resource usage, the method comprising: sampling, at a client computing system comprising one or more computing devices, one or more negative class labels from a negative sampling distribution, wherein the client computing system comprises a local training dataset, the local training dataset comprising a plurality of training examples each associated with one of a plurality of local positive class labels: communicating, by the client computing system, a client class set comprising a union of the one or more negative class labels with the plurality of local positive class labels to a server computing system, the server computing system comprising a current version of a machine-learned global classification model configured to provide class labels associated with a plurality of candidate classes; receiving, by the client computing system, data descriptive of a classification submodel, the classification submodel configured to provide a classification output limited to classes of the client class set: determining, by the client computing system, a model update based at least in part on a sampled SoftMax loss, the sampled SoftMax loss determined based at least in part on use of the classification submodel with the local training dataset at the client computing system; and communicating, by the client computing system, the model update to the server computing system, wherein the current version of the machine-learned global classification model is updated based at least in part on the model update.

Another example aspect of the present disclosure is directed to a computer-implemented method for federated learning of a machine-learned model with reduced computing resource usage, the method comprising: receiving, by a server computing system comprising one or more computing devices, one or more class sets from one or more client computing systems, the one or more class sets comprising, for each client computing system of the one or more client computing systems, a plurality of local positive class labels respective to a plurality of training examples of a local training dataset at the client computing system and one or more negative class labels sampled by the client computing system: communicating, by the server computing system, data descriptive of a respective classification submodel to each client computing system of the one or more client computing systems, wherein the respective classification submodel is configured to provide a classification output limited to the client class set received from the client computing system; receiving, by the server computing system, one or more model updates from the one or more client computing systems: aggregating, by the server computing system, the one or more model updates to produce an aggregate model update; and updating, by the server computing system, a machine-learned global classification model based at least in part on the aggregate model update.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs federated learning with sampled SoftMax according to example embodiments of the present disclosure.

FIG. 1B depicts a block diagram of an example computing device that performs federated learning with sampled SoftMax according to example embodiments of the present disclosure.

FIG. 1C depicts a block diagram of an example computing device that performs federated learning with sampled SoftMax according to example embodiments of the present disclosure.

FIG. 2 depicts a block diagram of a system for training one or more global machine learning models using respective training data stored locally on a plurality of client devices according to example embodiments of the present disclosure.

FIG. 3 depicts a block diagram of an example classification model according to example embodiments of the present disclosure.

FIG. 4 depicts a diagram of an example federated learning with sampled SoftMax configuration according to example embodiments of the present disclosure.

FIG. 5 depicts a flow diagram of an example method of updating a global model according to example embodiments of the present disclosure.

FIG. 6 depicts a flow chart diagram of an example method to perform federated learning with sampled SoftMax according to example embodiments of the present disclosure.

FIG. 7 depicts a flow chart diagram of an example method to perform federated learning with sampled SoftMax according to example embodiments of the present disclosure.

Reference numerals that are repeated across plural figures are intended to identify the same features in various implementations.

### DETAILED DESCRIPTION

Generally, the present disclosure is directed to systems and methods for federated learning of machine-learned models with sampled SoftMax. Federated learning refers to an approach for training machine-learned model(s) in which a learner is provided with model updates to a global model from a plurality of client devices, which may be based on use of the model at the client devices. Federated learning may also be referred to as decentralized learning, or learning with decentralized data. Learning (e.g., image representations) on decentralized data can bring many benefits in cases where data cannot be aggregated across data silos. As an example, SoftMax cross entropy loss can be used for learning image representations. Using a large number of classes has proven to be particularly beneficial for the descriptive power of such representations in centralized learning. However, doing so on decentralized data with federated learning is not straightforward, as the demand on computation and communication increases proportionally to the number of classes. Example aspects of the present disclosure provide a novel, resource-efficient approach for learning image representation with federated learning, which can be referred to as federated sampled SoftMax. According to example aspects of the present disclosure, the federated learning clients sample a set of negative classes and optimize only the corresponding model parameters with respect to a sampled SoftMax objective that approximates the global full SoftMax objective. This approach significantly reduces the number of parameters transferred to and optimized by the client devices, while performing on par with the standard full SoftMax method. This creates a possibility for efficiently learning image representations on decentralized data with a large number of classes in a privacy preserving way.

The success of many computer vision applications, such as classification, detection, and retrieval, relies heavily on the quality of the learned image representation. Many approaches have been proposed to learn better image representation from centrally stored datasets. For example, the contrastive and the triplet losses enforce local constraints among individual instances while taking a long time to train on O (N²) pairs and O (N³) triplets for N labeled training examples, respectively. A more efficient way to train image representation is via SoftMax cross entropy loss which involves only O(N) inputs. The scale of a classification problem could be defined by the total number of classes involved, number of training samples available or both. Many high performing computer vision models are trained on centrally stored large-scale datasets using the classification loss. In particular, using an extremely large number of classes (sometimes millions) has proven to be beneficial for learning universal feature representations. However, collecting such datasets is expensive and/or can unintentionally expose private information. For instance, training image classification with a significant number of classes requires a large amount of computational resources.

Example aspects of the present disclosure are directed to learning representations (e.g., image representations) using the classification loss on decentralized data with federated learning. Example aspects of the present disclosure are discussed for the purposes of illustration with respect to the cross-device scenario, where the clients are edge devices with limited computational resources, such as smartphones. As the total number of classes increases, the communication cost and computation operations for training a classification model in the federated learning setting grow proportionally. In particular, the total number of parameters in a model can be dominated by those in its classification layer. Being resilient to the growth of the problem scale is desirable for federated learning with resource-constrained devices.

Example aspects of the present disclosure provide a novel method for efficient image representation learning on decentralized data using the classification loss. For instance, example aspects of the present disclosure recognize that, despite a possibly large label space a problem may have, it is likely that every edge device holds data from only a small subset of the classes. The goal is thus to train a model with a large total number of classes while having a significantly small subset of parameters delivered to and optimized by the federated learning clients. This approach provides that clients can learn a robust image representation (visual embedding) while lowering the number of parameters transferred between the federated learning server and clients. In particular, example aspects of the present disclosure employ a client-driven negative class sampling mechanism and formulate a sampled SoftMax loss specifically for the federated learning setting. The federated learning clients are responsible for sampling negative classes and requesting a sub network from the federated learning server by sending a set of class labels that anonymizes the clients' true class labels in its local dataset. The clients then optimize a sampled SoftMax loss that involves both the clients' sampled negative classes as well as its local positive classes, and thus approximating the global full SoftMax objective.

In some implementations, the requested sub network consists of a feature extractor and a sub classifier. The feature extractor is the first half of the full network which takes an image as input and produces image representation as output. The sub classifier contains class representations corresponding to the received class labels.

Example aspects of the present disclosure can also provide solutions for a problem space with relaxed assumptions relative to some other approaches. For instance, some approaches assume or require that every client holds data for a single fixed class label. In contrast, example aspects of the present disclosure can provide for clients to hold data from multiple classes, especially some limited subset (e.g., less than about 10%) of the total set of classes, although example aspects of the present disclosure can find application even if the clients hold and/or sample greater than about 10% of the total set of classes, and this is not intended to limit the scope of the present disclosure unless indicated otherwise. As another example, some approaches transmit only a corresponding class label for a client. However, example aspects of the present disclosure can approximate a global full SoftMax cross-entropy objective.

Example aspects of the present disclosure are discussed with reference to a global SoftMax cross-entropy objective. For instance, the SoftMax cross-entropy objective can be used in training a model for a multi-class classification problem having n classes, for which each given input x has a correct class y∈[0,1]ⁿ of the n classes. For instance, the sum over all classes may sum to a maximum value (e.g., 1), or Σᵢ₌₁ⁿ yᵢ=1. A classifier model is learned that computes a classification output that classifies the input into one of the classes. As an example, the classifier may compute a d-dimensional feature representation (e.g., f(x)∈ [symbol] ) and/or a logit score (e.g., oᵢ=wᵢ^{T}f(x)+b∈ [symbol] ) for each class i∈[n]. Let t∈[n] be the true class label for the input x such that yt=1.

A SoftMax distribution can be formed by the class probabilities computed from the logit scores using the SoftMax function

$${p}_{i} = \frac{exp ( {o}_{i} )}{{\sum }_{j = 1}^{n} exp ( {o}_{j} )} ,$$

i∈[n]. In addition, the SoftMax cross-entropy loss for the training example (x, y) may be defined as [symbol] (x, y)=−Σᵢ₌₁ⁿyᵢ log pᵢ=−oₜ++log Σⱼ₌₁ⁿ exp (oⱼ). Note that the second term of this equation involves computing the logit scores oⱼ for all the n classes. In particular, as the number of classes n increases, the number of columns in the weight matrix W≡[w₁, w₂, . . . , wₙ]∈ [symbol] of the classification layer also increases. This can provide that the complexity of computing this full SoftMax loss grows linearly with number of classes.

Sampled SoftMax can reduce computational resources (e.g., memory usage, computation time, number of compute cycles, etc.) used in evaluating a full SoftMax objective. In the sampled SoftMax approach, class probabilities are approximated using a subset N of negative classes whose size m≡| [symbol] |<<n. These negative classes can be sampled from a proposal distribution Q, with qᵢ being the sampling probability of the class i. Using the adjusted logits o′ⱼ=oⱼ−log (mqⱼ), ∀j∈ [symbol] , the target class probability can be approximated with

$${p}_{t}^{′} = \frac{exp ( {o}_{t}^{′} )}{exp ( {o}_{t}^{′} ) + {\sum }_{j ∈ 𝒩} exp ( {o}_{j}^{′} )} .$$

This leads to the sampled softmax cross-entropy loss [symbol] _{sampled}(x, y)=−o′ₜ+log [symbol] exp (o′ⱼ). The logit adjustments o′ⱼ resemble the weights in importance sampling. For instance, as m→∞, the derivative ∇ [symbol] _{sampled} yields an unbiased estimate of that of the full softmax loss ∇ [symbol] =−∇oₜ+ [symbol] ₚ[∇oⱼ].

Example aspects of the present disclosure provide for sampled SoftMax for training machine-learned models in federated learning. For instance, in a federated learning configuration, a federated learning server (e.g., a server computing system) drives a learning procedure by sending a current global version of a machine-learned model (e.g., current model parameters θₜ at round t) to one or more federated learning clients (e.g., client computing devices). For instance, the model may be sent to a subset of K clients out of a larger plurality of clients. These clients perform local optimization with respect to the current global version of the model θₜ using a local dataset available to the client devices [symbol] ₖ to determine a model change Δθₜ^{(k)}. The model change is then reported back to the server. The server then aggregates the received model changes {Δθₜ^{(k)}}ₖ₌₁^{K} from the subset of clients and updates the global model θₜ₊₁ based on the aggregated updates. This constitutes one learning round, which is then repeated multiple times with different selected clients each round. Throughout the learning process, the local data on the client devices is not made available to the server. In this manner, a model can be updated based on local data while maintaining privacy, security, etc. of the local data, and without requiring transmission or knowledge of the local data. This approach can be particularly beneficial in privacy-sensitive applications.

This example framework can be referred to as FedAvg. One major assumption in FedAvg is that the model optimized by the server and clients have the exact same architecture. For instance, consider a ConvNet classifier for n classes, where the weight matrix in the classification layer alone contains nd parameters, where d is the dimensionality of the feature output by the previous layer. With the configuration of the convolutional layers unchanged, the communication between a client and the server, as well as the local storage required on the client device, are O (nd). In the cross-device federated learning scenario, where the clients are edge devices having relatively limited computational resources, such as smartphones, the scale of the classifiers which could be trained is constrained by computational resources. Example aspects of the present disclosure provide for overcoming these and other challenges.

One example aspect of the present disclosure is directed to a computer-implemented method for federated learning of a machine-learned model with reduced computing resource usage. The computer-implemented method(s) according to example aspects of the present disclosure can be implemented at a computing system comprising one or more computing devices. For example, the computing system can be a server computing system and/or a client computing system. In some implementations, the client computing system can be a mobile device, such as a smartphone, smart watch, mobile phone, laptop computer, smart display, smart speaker, pager, PDA, and/or other suitable mobile device, or any other suitable computing device or system (e.g., a desktop computer).

The computer-implemented method can include sampling (e.g., at a client computing system comprising one or more computing devices) one or more negative class labels from a negative sampling distribution. For instance, the client computing system can include a local training dataset having a plurality of training examples each associated with one of a plurality of local positive class labels, denoted Pₖ. The training dataset can include any suitable type of data, such as data corresponding to a function for which the classification model will ultimately be used. As one example, the training dataset can include image data, such as a plurality of image examples (e.g., image examples labeled with a proper classification for the images).

It can be desirable that the negative sampling is implemented while providing for the privacy-preserving benefits that may be achieved through Federated Learning. For instance, data is desirably not exposed to the server. In addition, it is desirable that any transmitted data does not reveal personally identifiable information about the client. In addition, the sampler can desirably be unbiased in estimating the gradient of the full SoftMax loss. Thus, the client can sample one or more negative class labels to obfuscate its transmitted set of class labels such that the presence of a class in a transmitted class set does not guarantee that the class is actually present in the client's training dataset.

Similar to the client's set of sampled negative class labels [symbol] , its set of positive class labels [symbol] ₖ also plays an important role. To see this, consider the equation [symbol] (x, y)=log [1+ [symbol] exp (o′ⱼ−o′ₜ)]. This loss pulls the input image representation f (x; φ) and positive class representation wₜ closer, while pushing the representation of the negative classes away from f(x; φ). Utilizing [symbol] ₖ/t as additional set of negatives to compute the equation enables the separation of classes in [symbol] ₖ with respect to each other as well as with respect to the classes in [symbol] . Alternatively, not utilizing [symbol] ₖ/t as the additional negatives in the equation leads to a Negatives-Only loss [symbol] (x, y)=log [1+ [symbol] exp (o′ⱼ−o′ₜ)], where t∈ [symbol] ₖ only contributes to computing the true logit for individual inputs, while the same [symbol] is shared across the inputs for approximating the full softmax probability. With this Negatives-Only loss, trivial solutions can be found for a client's local optimization problem. It encourages the separation of [symbol] ₖ from [symbol] in the representation space, which can be easily achieved by increasing the magnitude of representations in [symbol] ₖ and reducing it for those in [symbol] without proper regularization. In addition, the learned representations can collapse, as the local optimization is reduced to a binary classification problem between the on-client classes [symbol] ₖ and off-client classes [symbol] . In contrast, using only the local positives [symbol] ₖ without the sampled negative classes [symbol] can lead to local objectives being different from the global objective, and therefore results in suboptimal solutions.

Any number of classes can be sampled as the negative classes. As the sample size increases, it is observed that the proposed sampled softmax loss better approximates the full softmax loss and as a result improves performance. However, it has also been observed that, in some implementations, a sample size of about 10% of the total number of classes (e.g., including local positive classes and/or sampled negative classes) sufficiently approximates the full softmax loss, and increased sample size has limited effect.

In some implementations, the sampling distribution can be a uniform distribution. For instance, in some implementations, the sampling distribution can be a uniform distribution over the plurality of candidate classes not included in the plurality of local positive class labels. Using a uniform distribution is a simple yet effective choice that satisfies all the aforementioned properties. First, [symbol] can be viewed as noisy samples from the maximum entropy distribution over [n]/Pₖ that mask the clients' positive class labels. From the server's perspective, it is not able to identify which labels in the union set [symbol] ₖ of the positive and negative class labels belong to the clients' dataset. In practice, private information retrieval techniques can further be used such that no identity information about the set is revealed to the server. Second, sampling negative classes with a uniform distribution covering the entire label space eliminates sampling bias.

Additionally, the method can include communicating, by the client computing system, a client class set including a union of the one or more negative class labels with the plurality of local positive class labels to a server computing system. Example aspects of the present disclosure provide a client-driven negative class sampling approach. Assuming the label space is known, clients locally sample negative classes from the full set of classes not including the locally positive classes (e.g., [n]/Pₖ) and communicate the class set including a union of the sampled negative classes with the locally positive classes (e.g., the set of class labels [symbol] ₖ= [symbol] ₖ∪ [symbol] ) to the server for requesting the corresponding model parameters. The set can be communicated in any suitable manner, such as by any manner of wired and/or wireless communication protocol (e.g., IEEE 802.11, local area networks, internet protocols, etc.).

The server computing system can include a current version of a machine-learned global classification model configured to provide class labels associated with a plurality of candidate classes. For instance, the global classification model can output class labels for at least the classes at all of the client devices. The global classification model can represent an overall objective (e.g., an overall SoftMax objective) that is trained by the use of a plurality of reduced-size submodels at client devices.

Additionally, the server computing system can receive one or more class sets from one or more client computing systems. The one or more class sets can include, for each client computing system of the one or more client computing systems, a plurality of local positive class labels respective to a plurality of training examples of a local training dataset at the client computing system and one or more negative class labels sampled by the client computing system. For instance, the server computing system can receive a class set from each client computing system that includes a class set including positive classes at that client and negative classes sampled by that client. The server computing system can be unable to discern the positive classes from the negative classes, such that the server cannot learn which classes are present at the client. For instance, the client class set can be anonymized such that the server computing system cannot discern the plurality of local positive class labels from the one or more negative class labels.

The server computing system can then communicate data descriptive of a respective classification submodel to each client computing system of the one or more client computing systems, wherein the respective classification submodel is configured to provide a classification output limited to the client class set received from the client computing system. For instance, the classification submodel can be a reduced version of the global classification model. The method can include receiving, by the client computing system, data descriptive of a classification submodel, the classification submodel configured to provide a classification output limited to classes of the client class set.

For instance, in some implementations, the global classification model can include a feature extractor and a classifier model. For instance, the global classification model may be a ConvNet classification model. The feature extractor can receive input data that is input into the global classification model and, in response to receipt of the input data, produce a feature representation of the input data. As one example, the feature extractor can be or can include a backbone network, such as a neural network. The classification submodel can additionally include the feature extractor. For instance, the (e.g., complete) feature extractor can be included in the classification submodel. Additionally and/or alternatively, the global classification model can include a classifier model that classifies the feature representation. For example, the classifier model can output one or more logit scores for each of the plurality of candidate classes based on the feature representation. The classifier model can include class representations corresponding to each of the plurality of candidate classes. As one example, the classifier model can be or can include a classifier weight matrix.

According to example aspects of the present disclosure, the classification submodel can be a reduced version of the global classification model. For example, the classification submodel can include a sub classifier model. The sub classifier model can be a reduced version of the classifier model of the global classification model. For instance, in some implementations, the sub classifier model can include class representations for only the classes in the client class set (e.g., as provided by the client). As an example, the sub classifier model can be or can include a sub classifier weight matrix. The sub classifier weight matrix can include class representations only for classes in the client class set. For instance, in one example implementation, the classifier model of the global classification model can include a weight matrix having columns for each class in the plurality of candidate classes. A class set (e.g., including positive classes and sampled negative classes) can be received from a client, and the submodel that is transmitted to that client by the server can include a sub classifier model have a sub weight matrix having (e.g., only) columns from the classifier model that correspond to the classes in the class set. In this way, the client can effectively request a smaller weight matrix that requires fewer computing resources (e.g., bandwidth, memory, etc.) to store and/or transmit, but which is still useful for determining a gradient to train the global classification model.

Additionally, the method can include determining, by the client computing system, a model update based at least in part on a sampled SoftMax loss. The sampled SoftMax loss can be determined based at least in part on use of the classification submodel with the local training dataset at the client computing system. For instance, once the submodel is received, the client computing system can provide the training examples from the training dataset as inputs to the classification submodel. In response to receipt of the training examples, the classification submodel can produce a local classification output based on a training example. The local classification output and a true class label of the training example can be used to determine a SoftMax loss. The SoftMax loss can then be used to determine a model update for the submodel, and thereby the global model.

As one example, the sampled SoftMax loss can include a sum of an adjusted logit for a true class label and a logarithm of a sum of the exponents of adjusted logits for all classes in the client class set. For instance, this can be mathematically represented by L_{sampled}^{(k)}(x, y)=−o′ₜ+log [symbol] exp (o′ⱼ), where o′ᵢ denotes an adjusted logit for class i. In some implementations, the adjusted logits can be the sum of a full SoftMax logit (e.g., a logit from a full SoftMax algorithm) and the logarithm of a number of negative classes multiplied by a sampling probability. For instance, the adjusted logits can be represented by oⱼ=o′ⱼ−log (mqₖ), ∀j∈ [symbol] , where m is a number of negative classes (e.g., a size of a subset [symbol] of negative classes whose size m≡| [symbol] |<<n), and where qⱼ is a sampling probability of the class/in the sampling distribution.

Additionally, the method can include communicating, by the client computing system, the model update to the server computing system, wherein the current version of the machine-learned global classification model is updated based at least in part on the model update. The server computing system can receive the one or more model updates from the one or more client computing systems. For instance, the server computing system can receive model updates from some or all of the client computing systems that are selected for a given learning round. The server computing system can then aggregate the one or more model updates to produce an aggregate model update. For instance, the server computing system can sum the one or more model updates to produce the aggregate model update. The server computing system can then update the machine-learned global classification model based at least in part on the aggregate model update. This can be repeated until the global classification model is sufficiently trained (e.g., converges to near-optimal parameters).

Example aspects of the present disclosure provide for a number of technical effects and benefits, including improvements to computing technology. For instance, systems and methods according to example aspects of the present disclosure can provide performance that is on par with full SoftMax training (e.g., in which all classes are used) while requiring only a fraction of the computational cost, especially in cases having a large number of classes. For instance, in some implementations, randomly sampling around only 10% of the parameters from the classification layer, or fewer, can provide comparable performance to full SoftMax while requiring fewer class representations (e.g., in the classification submodel) transmitted to and/or from the clients and/or to be optimized by the clients. Additionally, systems and methods according to example aspects of the present disclosure can be resilient to growth of scale. For instance, systems and methods according to example aspects of the present disclosure can provide for a relatively reduced rate of growth of required computational resources with respect to, e.g., number of classes or other problem parameter(s). This can provide for improved feasibility of applying federated learning to train on large corpuses of decentralized data. Systems and methods according to example aspects of the present disclosure can additionally be robust to learning rate increases. For instance, systems and methods according to example aspects of the present disclosure can converge, or avoid becoming unstable, for large learning rate values. This can provide for faster (e.g., in a reduced number of learning cycles) convergence of the model parameters to final values, thus improving speed and/or reducing a number of learning cycles and/or reducing computational, electrical, or other cost required to train the model. Systems and methods can also provide for avoiding overfitting, as only a subset of class representations is updated for each round of federated learning. Improved performance may consequently be achieved across a range of technical tasks, including image and other classification tasks. For example, the output provided by the model may be a set of scores, each score corresponding to a different object class and representing the likelihood that the one or more images depict an object belonging to the object class. The models obtained by the disclosed method may also perform a range of further technical tasks, as set out in more detail below.

With reference now to the Figures, example embodiments of the present disclosure will be discussed in further detail.

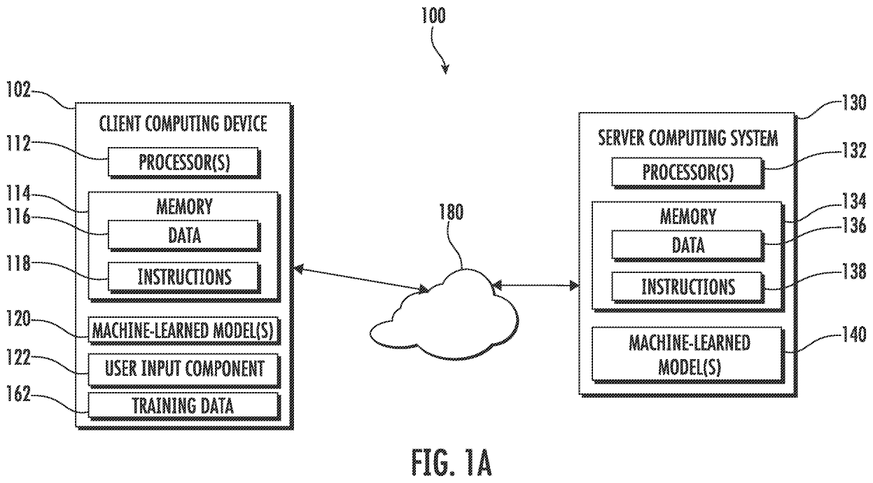

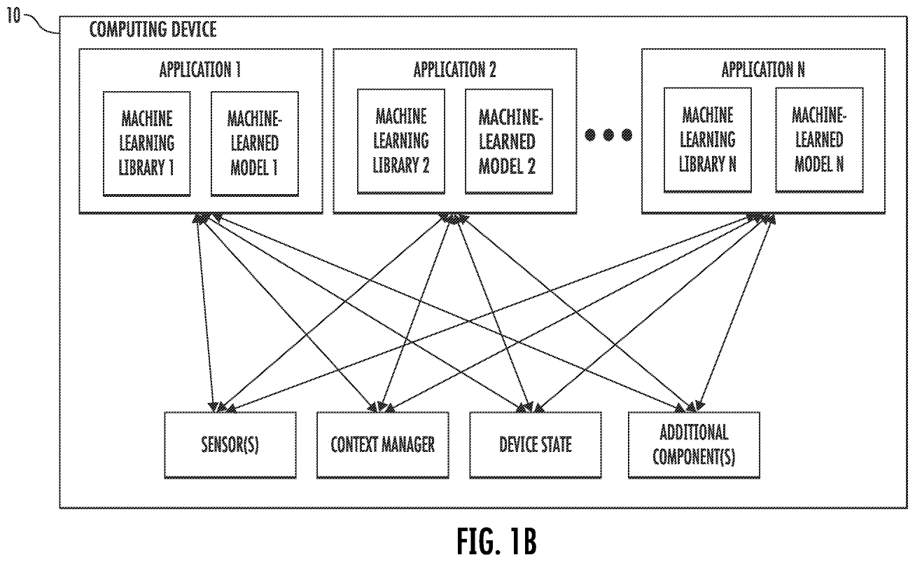

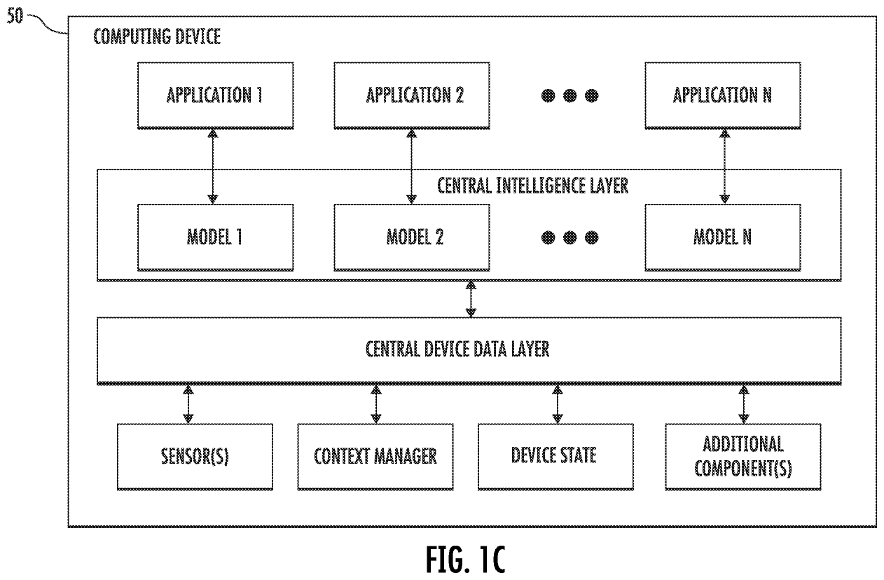

FIG. 1A depicts a block diagram of an example computing system 100 that performs federated learning with sampled SoftMax according to example embodiments of the present disclosure. The system 100 includes a client computing device 102, a server computing system 130, and a training computing system 150 that are communicatively coupled over a network 180.

The client computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The client computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the client computing device 102 to perform operations.

In some implementations, the client computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more machine-learned models 120 can be received from the server computing system 130 over network 180, stored in the client computing device memory 114, and then used or otherwise implemented by the one or more processors 112. In some implementations, the client computing device 102 can implement multiple parallel instances of a single machine-learned model 120 (e.g., to perform parallel classification across multiple instances of models).

Additionally or alternatively, one or more machine-learned models 140 can be included in or otherwise stored and implemented by the server computing system 130 that communicates with the client computing device 102 according to a client-server relationship. For example, the machine-learned models 140 can be implemented by the server computing system 130 as a portion of a web service (e.g., an image classification service). Thus, one or more models 120 can be stored and implemented at the client computing device 102 and/or one or more models 140 can be stored and implemented at the server computing system 130.

The client computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The computing devices/systems 102, 130 can train the machine-learned models 120 and/or 140 stored at the client computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The computing devices/systems 102, 130 can perform a number of generalization techniques (e.g., weight decays, dropouts, etc.) to improve the generalization capability of the models being trained.

In particular, the client computing device 102 can include training data 162 such as a local training dataset including a plurality of training examples. The training examples can be used in the federated learning with sampled SoftMax approach described herein to train the models 120, 140.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the client computing device 102 can include the model trainer 160 and the training dataset 162. In such implementations, the models 120 can be both trained and used locally at the client computing device 102. In some of such implementations, the client computing device 102 can implement the model trainer 160 to personalize the models 120 based on user-specific data.

FIG. 1B depicts a block diagram of an example computing device 10 that performs according to example embodiments of the present disclosure. The computing device 10 can be a client computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a client computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

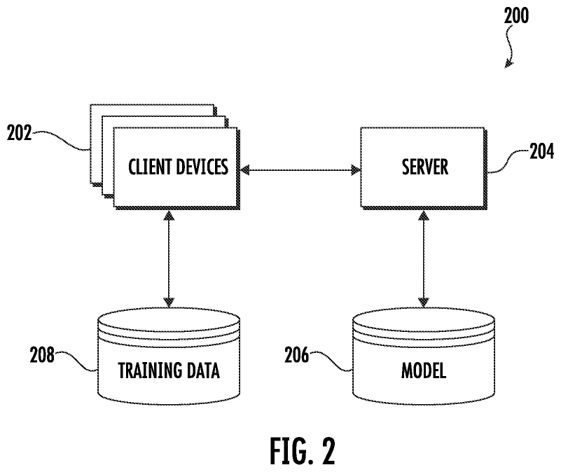

FIG. 2 depicts an example system 200 for training one or more global machine learning models 206 using respective training data 208 stored locally on a plurality of client devices 202. System 200 can include a server device 204. Server 204 can be configured to access machine learning model 206, and to provide a submodel that is a reduced version of model 206 to a plurality of client devices 202, as described herein. Model 206 can be, for instance, a classifier model, a linear regression model, logistic regression model, a support vector machine model, a neural network (e.g. convolutional neural network, recurrent neural network, etc.), or other suitable model. In some implementations, server 204 can be configured to communicate with client devices 202 over one or more networks.

Client devices 202 can each be configured to determine one or more local updates associated with model 206 based at least in part on training data 208. For instance, training data 208 can be data that is respectively stored locally on the client devices 202. The training data 208 can include audio files, image files, video files, a typing history, location history, and/or various other suitable data. In some implementations, the training data can be any data derived through a user interaction with a client device 202.

Further to the descriptions above, a user may be provided with controls allowing the user to make an election as to both if and when systems, programs or features described herein may enable collection, storage, and/or use of user information (e.g., training data 208), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Although training data 208 is illustrated in FIG. 2 as a single database, the training data 208 consists of data that is respectively stored at each device 202. Thus, in some implementations, the training data 208 is highly unbalanced and not independent and identically distributed.

Client devices 202 can be configured to provide the local updates to server 204. As indicated above, training data 208 may be privacy sensitive. In this manner, the local updates can be performed and provided to server 204 without compromising the privacy of training data 208. For instance, in such implementations, training data 208 is not provided to server 204. The local update does not include training data 208. In some implementations in which a locally updated model is provided to server 204, some privacy sensitive data may be able to be derived or inferred from the model parameters. In such implementations, one or more of encryption techniques, random noise techniques, and/or other security techniques can be added to the training process to obscure any inferable information.

As indicated above, server 204 can receive each local update from client device 202, and can aggregate the local updates to determine a global update to the model 206. In some implementations, server 204 can determine an average (e.g., a weighted average) of the local updates and determine the global update based at least in part on the average.

In some implementations, scaling or other techniques can be applied to the local updates to determine the global update. For instance, a local step size can be applied for each client device 202, the aggregation can be performed proportionally to various data partition sizes of client devices 202, and/or one or more scaling factors can be applied to the local and/or aggregated updates. It will be appreciated that various other techniques can be applied without deviating from the scope of the present disclosure.

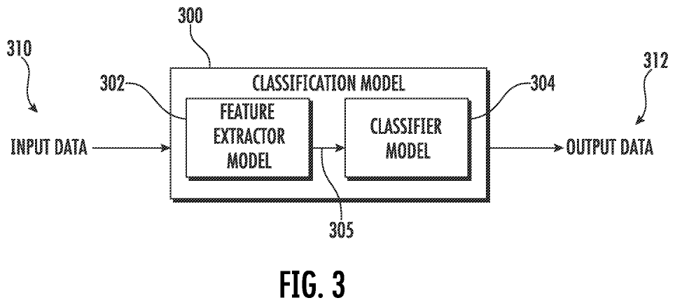

FIG. 3 depicts a block diagram of an example classification model 300 according to example embodiments of the present disclosure. For instance, the global classification model 300 may be a ConvNet classification model. The global classification model 300 can include feature extractor 302. The feature extractor 302 can receive input data 310 that is input into the global classification model 300 and, in response to receipt of the input data 310, produce a feature representation 305 of the input data 310. As one example, the feature extractor 302 can be or can include a backbone network, such as a neural network. Additionally and/or alternatively, the global classification model 300 can include a classifier model 304 that classifies the feature representation 305. For example, the classifier model can produce output data 312 including a classification output, such as one or more logit scores for each of the plurality of candidate classes based on the feature representation 305. The classifier model 304 can include class representations corresponding to each of the plurality of candidate classes. As one example, the classifier model 304 can be or can include a classifier weight matrix.

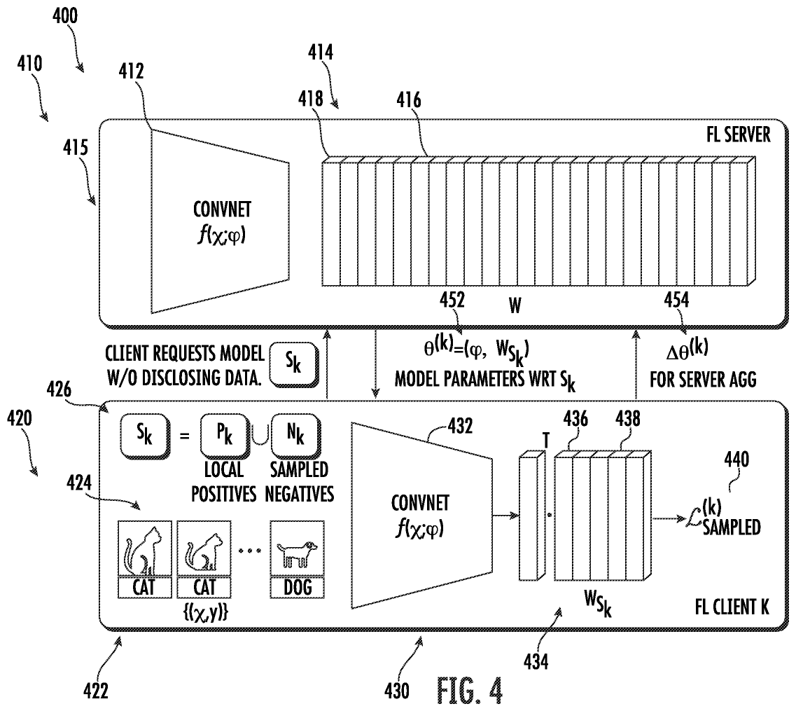

FIG. 4 depicts a diagram of an example federated learning with sampled SoftMax configuration 400 according to example embodiments of the present disclosure. As illustrated in FIG. 4, a server device 410 can be in communication with a client device 420. The client device 420 can be a client device k of a plurality of client devices that are employed for a round of federated learning. The other client devices may be similar to and/or identical to the client device 410, and/or may differ from client device 410. The server device 410 can include a global classification model 415. The global classification model 415 can include a feature extractor 412 (e.g., a ConvNet network). The feature extractor 412 can be parametrized by one or more feature extractor parameters (e.g., φ). The feature extractor 412 can produce a feature representation of input data.

Additionally, the server device 410 can include a classifier model 414, and in particular a weight matrix 414. The weight matrix 414 can include a plurality of columns W corresponding to feature representations of each of a plurality of classes. For instance, the weight matrix 414 can receive the feature representation output by feature extractor 412 and, based on the columns, output a classification score (e.g., logit) for each class.

Additionally, the client device 420 can include a local training dataset 422. The local training dataset 422 can include a plurality of training examples 424. As illustrated in FIG. 4, the training examples 424 (e.g., x) can be labeled with class labels (e.g., y) representing a ground truth classification of the training examples 424. Generally, it may be desirable that the training examples 424 are not made available to the server computing system 410, but are nonetheless used to train the global classification model 415 in accordance with example aspects of the present disclosure. The client class set 426 (e.g., [symbol] ₖ) can include the local positive class labels, corresponding to classes for which there is at least one ground truth class label in the training examples 424. Additionally, the client class set can include sampled negative class labels that are sampled from a sampling distribution (e.g., a uniform distribution) in accordance with example aspects of the present disclosure.

The client device 420 can communicate the client class set 426 to the server device 410. In response to receiving the client class set 426, the server device 410 can communicate a classification submodel 430 to the client device 410 based at least in part on the client class set 426. For example, the server device 410 can communicate model parameters 452 of the classification submodel 430. As an example, the model parameters 452 can include the (e.g., identical) feature extractor parameters (e.g., φ). Additionally, the model parameters 452 can include a sub weight matrix 434 having a subset of columns [symbol] from the weight matrix 414 (e.g., W) that correspond to the classes in the client class set, [symbol] ₖ. For instance, as illustrated in FIG. 4, the highlighted columns 416 represent columns of the weight matrix 414 that are included in the sub weight matrix 434, such as columns corresponding to one of the classes in the client class set 426. Additionally and/or alternatively, the shaded columns 418 represent other columns of the weight matrix 414 that are not included in the sub weight matrix 434 and/or the client class set 426. Thus, as illustrated, a subset of the columns of weight matrix 414 are included in sub weight matrix 434. In addition to the sub weight matrix 434, the classification submodel 430 can include the feature extractor 432. The feature extractor 432 can be parameterized with the same feature extractor parameters as the feature extractor 412 of the global classification model 415.

As illustrated in FIG. 4, the columns 436 of the sub weight matrix 434 can correspond to local positive classes of the training dataset 422. In addition to these local positive columns 436, the sub weight matrix 434 can include columns 438 corresponding to negative classes, such as classes that are sampled and thereby included in the client class set 426, but which are not actually present in training dataset 422. The inclusion of negative columns 438 can serve to obfuscate the local positive classes in training dataset 422 in addition to and/or alternatively to providing improved training performance of the submodel 430.

The client device 420 can provide the training examples 424 as input to the classification submodel 430. Output from the classification submodel 430 can be compared with the ground truth class labels of the training examples 424 to produce loss 440. The loss 440 can then be used to determine model update 454. The client device 420 can communicate the model update 454 to the server device 410. The server device 410 can then update the global classification model 415 based at least in part on the model update 454. For instance, the server device 410 can aggregate the model update 454 with one or more additional model updates from one or more additional client devices to determine an aggregate model update. The aggregate model update can then be used to update the global classification model 415.

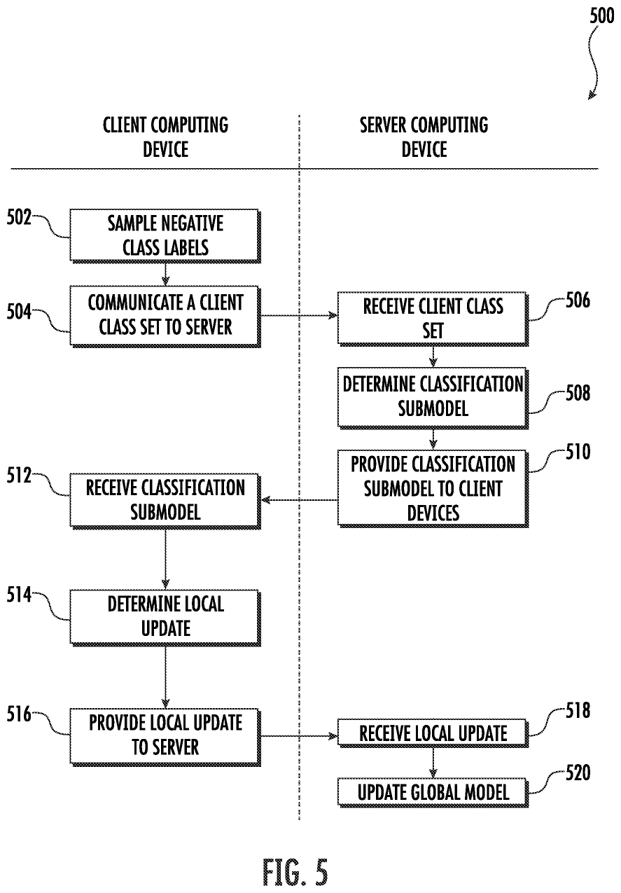

FIG. 5 depicts a flow diagram of an example method (500) of updating a global model according to example embodiments of the present disclosure. Method (500) can be implemented by one or more computing devices, such as one or more of the computing devices depicted in FIGS. 1 and/or 2. In addition, FIG. 5 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

At (502), method (500) can include sampling (e.g., at a client computing system comprising one or more computing devices) one or more negative class labels from a negative sampling distribution. For instance, the client computing system can include a local training dataset having a plurality of training examples each associated with one of a plurality of local positive class labels. The training dataset can include any suitable type of data, such as data corresponding to a function for which the classification model will ultimately be used. As one example, the training dataset can include image data, such as a plurality of image examples (e.g., image examples labeled with a proper classification for the images).

At (504), method (500) can include communicating, by the client computing system, a client class set including a union of the one or more negative class labels with the plurality of local positive class labels to a server computing system. Example aspects of the present disclosure provide a client-driven negative class sampling approach. Assuming the label space is known, clients locally sample negative classes from the full set of classes not including the locally positive classes (e.g., [n]/Pₖ) and communicate the class set including a union of the sampled negative classes with the locally positive classes (e.g., the set of class labels [symbol] ₖ= [symbol] ₖ∪ [symbol] ) to the server for requesting the corresponding model parameters. The set can be communicated in any suitable manner, such as by any manner of wired and/or wireless communication protocol (e.g., IEEE 802.11, local area networks, internet protocols, etc.).

At (506), method (500) can include receiving (e.g., by a server computing system comprising one or more computing devices) one or more class sets from one or more client computing systems. The one or more class sets can include, for each client computing system of the one or more client computing systems, a plurality of local positive class labels respective to a plurality of training examples of a local training dataset at the client computing system and one or more negative class labels sampled by the client computing system. For instance, the server computing system can receive a class set from each client computing system that includes a class set including positive classes at that client and negative classes sampled by that client. The server computing system can be unable to discern the positive classes from the negative classes, such that the server cannot learn which classes are present at the client. For instance, the client class set can be anonymized such that the server computing system cannot discern the plurality of local positive class labels from the one or more negative class labels.

At (508), method (500) can include determining, by the server, a classification submodel based at least in part on the received client class set. For instance, the server computing system can determine that the classification submodel for a given client will include a feature extractor from a global classification model and a subset of columns from a weight matrix of the global classification model that correspond to classes in the client class set of the client.

At (510), method (500) can include providing the classification model to each client device, and at (512), method (500) can include receiving the global model at the client device.

At (514), method (500) can include determining, by the client device, a local update. In a particular implementation, the local update can be determined by using the classification submodel with the locally stored training data to produce the model update (e.g., local update).

At (516), method (500) can include providing, by the client device, the local update to the server. In some implementations, the local model or local update can be encoded prior to sending the local model or update to the server.

At (518), method (500) can include receiving, by the server, the local update. In particular, the server can receive a plurality of local updates from a plurality of client devices.

At (520), method (500) can include updating the global model. In particular, the global model can be updated based at least in part on the received local update(s). For instance, the received local updates can be aggregated to update the global model. The aggregation can be an additive aggregation and/or an averaging aggregation. In particular implementations, the aggregation of the local updates can be proportional to the partition sizes of the data examples on the client devices. In further embodiments the aggregation of the local updates can be scaled on a per-coordinate basis.

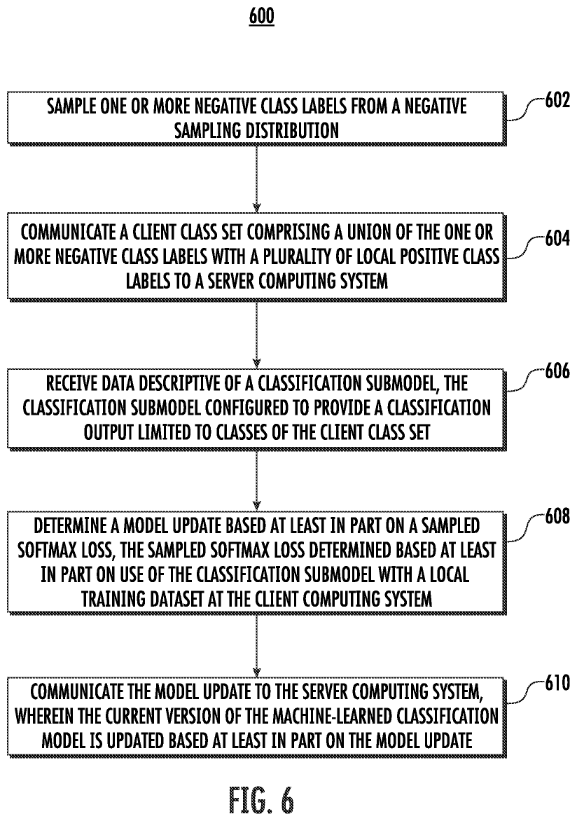

FIG. 6 depicts a flow chart diagram of an example method (600) to perform federated learning with sampled SoftMax according to example embodiments of the present disclosure. Although FIG. 6 depicts steps performed in a particular order for purposes of illustration and discussion, the methods of the present disclosure are not limited to the particularly illustrated order or arrangement. The various steps of the method (600) can be omitted, rearranged, combined, and/or adapted in various ways without deviating from the scope of the present disclosure.

The method (600) can include, at (602), sampling (e.g., at a client computing system comprising one or more computing devices) one or more negative class labels from a negative sampling distribution. For instance, the client computing system can include a local training dataset having a plurality of training examples each associated with one of a plurality of local positive class labels. The training dataset can include any suitable type of data, such as data corresponding to a function for which the classification model will ultimately be used. As one example, the training dataset can include image data, such as a plurality of image examples (e.g., image examples labeled with a proper classification for the images).

Similar to the client's sampled negatives [symbol] , its set of positive class labels [symbol] ₖ also plays an important role. To see this, consider the equation [symbol] (x,y)=log [1+ [symbol] exp (o′ⱼ−o′ₜ)]. This loss pulls the input image representation f (x; φ) and positive class representation wₜ closer, while pushing the representation of the negative classes away from f(x; φ). Utilizing [symbol] ₖ/t as additional set of negatives to compute the equation enables the separation of classes in [symbol] ₖ with respect to each other as well as with respect to the classes in [symbol] . Alternatively, not utilizing [symbol] ₖ/t as the additional negatives in the equation leads to a Negatives-Only loss [symbol] (x, y)=log [1+ [symbol] exp(o′ⱼ−o′ₜ)], where t∈ [symbol] ₖ only contributes to computing the true logit for individual inputs, while the same [symbol] ₖ is shared across the inputs for approximating the full softmax probability. With this Negatives-Only loss, trivial solutions can be found for a client's local optimization problem. It encourages the separation of [symbol] ₖ from [symbol] ₖ in the representation space, which can be easily achieved by increasing the magnitude of representations in [symbol] ₖ and reducing it for those in [symbol] ₖ without proper regularization. In addition, the learned representations can collapse, as the local optimization is reduced to a binary classification problem between the on-client classes [symbol] ₖ and off-client classes [symbol] ₖ. In contrast, using only the local positives [symbol] ₖ without the sampled negative classes [symbol] ₖ can lead to local objectives being different from the global objective, and therefore results in suboptimal solutions.

In some implementations, the sampling distribution can be a uniform distribution. For instance, in some implementations, the sampling distribution can be a uniform distribution over the plurality of candidate classes not included in the plurality of local positive class labels. Using a uniform distribution is a simple yet effective choice that satisfies all the aforementioned properties. First, [symbol] ₖ can be viewed as noisy samples from the maximum entropy distribution over [n]/ [symbol] ₖ that mask the clients' positive class labels. From the server's perspective, it is not able to identify which labels in [symbol] ₖ belong to the clients dataset. In practice, private information retrieval techniques can further be used such that no identity information about the set is revealed to the server. Second, sampling negative classes with a uniform distribution covering the entire label space eliminates sampling bias.

Any number of classes can be sampled as the negative classes. As the sample size increases, it is observed that the proposed sampled softmax loss better approximates the full softmax loss and as a result improves performance. However, it has also been observed that, in some implementations, a sample size of about 10% of the total number of classes sufficiently approximates the full softmax loss, and increased sample size has limited effect.

Additionally, the method (600) can include, at (604), communicating, by the client computing system, a client class set including a union of the one or more negative class labels with the plurality of local positive class labels to a server computing system. Example aspects of the present disclosure provide a client-driven negative class sampling approach. Assuming the label space is known, clients locally sample negative classes from the full set of classes not including the locally positive classes (e.g., [n]/Pₖ) and communicate the class set including a union of the sampled negative classes with the locally positive classes (e.g., the set of class labels [symbol] ₖ= [symbol] ₖ∪ [symbol] ) to the server for requesting the corresponding model parameters. The set can be communicated in any suitable manner, such as by any manner of wired and/or wireless communication protocol (e.g., IEEE 802.11, local area networks, internet protocols, etc.).

The server computing system can include a current version of a machine-learned global classification model configured to provide class labels associated with a plurality of candidate classes. For instance, the global classification model can output class labels for at least the classes at all of the client devices. The global classification model can represent an overall objective (e.g., an overall SoftMax objective) that is trained by the use of a plurality of reduced-size submodels at client devices.

Additionally, the server computing system can receive one or more class sets from one or more client computing systems. The one or more class sets can include, for each client computing system of the one or more client computing systems, a plurality of local positive class labels respective to a plurality of training examples of a local training dataset at the client computing system and one or more negative class labels sampled by the client computing system. For instance, the server computing system can receive a class set from each client computing system that includes a class set including positive classes at that client and negative classes sampled by that client. The server computing system can be unable to discern the positive classes from the negative classes, such that the server cannot learn which classes are present at the client. For instance, the client class set can be anonymized such that the server computing system cannot discern the plurality of local positive class labels from the one or more negative class labels.

The server computing system can then communicate data descriptive of a respective classification submodel to each client computing system of the one or more client computing systems, wherein the respective classification submodel is configured to provide a classification output limited to the client class set received from the client computing system. For instance, the classification submodel can be a reduced version of the global classification model. The method (600) can thus include, at (606), receiving, by the client computing system, data descriptive of a classification submodel, the classification submodel configured to provide a classification output limited to classes of the client class set.

For instance, in some implementations, the global classification model can include a feature extractor and a classifier model. For instance, the global classification model may be a ConvNet classification model. The feature extractor can receive input data that is input into the global classification model and, in response to receipt of the input data, produce a feature representation of the input data. As one example, the feature extractor can be or can include a backbone network, such as a neural network. The classification submodel can additionally include the feature extractor. For instance, the (e.g., complete) feature extractor can be included in the classification submodel. Additionally and/or alternatively, the global classification model can include a classifier model that classifies the feature representation. For example, the classifier model can output one or more logit scores for each of the plurality of candidate classes based on the feature representation. The classifier model can include class representations corresponding to each of the plurality of candidate classes. As one example, the classifier model can be or can include a classifier weight matrix.

According to example aspects of the present disclosure, the classification submodel can be a reduced version of the global classification model. For example, the classification submodel can include a sub classifier model. The sub classifier model can be a reduced version of the classifier model of the global classification model. For instance, in some implementations, the sub classifier model can include class representations for only the classes in the client class set (e.g., as provided by the client). As an example, the sub classifier model can be or can include a sub classifier weight matrix. The sub classifier weight matrix can include class representations only for classes in the client class set. For instance, in one example implementation, the classifier model of the global classification model can include a weight matrix having columns for each class in the plurality of candidate classes. A class set (e.g., including positive classes and sampled negative classes) can be received from a client, and the submodel that is transmitted to that client by the server can include a sub classifier model have a sub weight matrix having (e.g., only) columns from the classifier model that correspond to the classes in the class set. In this way, the client can effectively request a smaller weight matrix that requires fewer computing resources (e.g., bandwidth, memory, etc.) to store and/or transmit, but which is still useful for determining a gradient to train the global classification model.

Additionally, the method (600) can include, at (608) determining, by the client computing system, a model update based at least in part on a sampled SoftMax loss. The sampled SoftMax loss can be determined based at least in part on use of the classification submodel with the local training dataset at the client computing system. For instance, once the submodel is received, the client computing system can provide the training examples from the training dataset as inputs to the classification submodel. In response to receipt of the training examples, the classification submodel can produce a local classification output based on a training example. The local classification output and a true class label of the training example can be used to determine a SoftMax loss. The SoftMax loss can then be used to determine a model update for the submodel, and thereby the global model.

As one example, the sampled SoftMax loss can include a sum of an adjusted logit for a true class label and a logarithm of a sum of the exponents of adjusted logits for all classes in the client class set. For instance, this can be mathematically represented by L_{sampled}^{(k)}(x, y)=−o′ₜ+log [symbol] exp (o′ⱼ), where o′ᵢ denotes an adjusted logit for class i. In some implementations, the adjusted logits can be the sum of a full SoftMax logit (e.g., a logit from a full SoftMax algorithm) and the logarithm of a number of negative classes multiplied by a sampling probability. For instance, the adjusted logits can be represented by oⱼ=o′ⱼ−log (mqᵢ), ∀j∈ [symbol] , where m is a number of negative classes (e.g., a size of a subset [symbol] of negative classes whose size m≡| [symbol] |<<n), and where qⱼ is a sampling probability of the class j in the sampling distribution.

Additionally, the method (600) can include, at (610), communicating, by the client computing system, the model update to the server computing system, wherein the current version of the machine-learned global classification model is updated based at least in part on the model update. The server computing system can receive the one or more model updates from the one or more client computing systems. For instance, the server computing system can receive model updates from some or all of the client computing systems that are selected for a given learning round. The server computing system can then aggregate the one or more model updates to produce an aggregate model update. For instance, the server computing system can sum the one or more model updates to produce the aggregate model update. The server computing system can then update the machine-learned global classification model based at least in part on the aggregate model update. This can be repeated until the global classification model is sufficiently trained (e.g., converges to near-optimal parameters).

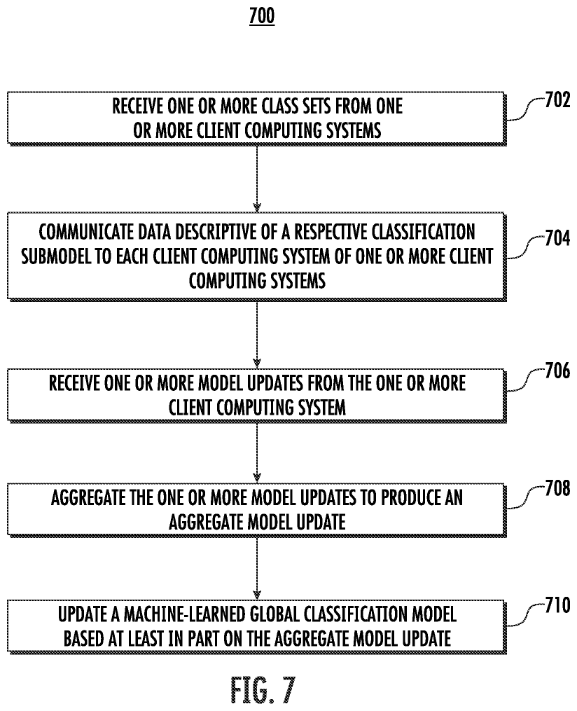

FIG. 7 depicts a flow chart diagram of an example method (700) to perform federated learning with sampled SoftMax according to example embodiments of the present disclosure. Although FIG. 7 depicts steps performed in a particular order for purposes of illustration and discussion, the methods of the present disclosure are not limited to the particularly illustrated order or arrangement. The various steps of the method (700) can be omitted, rearranged, combined, and/or adapted in various ways without deviating from the scope of the present disclosure.

The method (700) can include, at (702), receiving (e.g., by a server computing system comprising one or more computing devices) one or more class sets from one or more client computing systems. The one or more class sets can include, for each client computing system of the one or more client computing systems, a plurality of local positive class labels respective to a plurality of training examples of a local training dataset at the client computing system and one or more negative class labels sampled by the client computing system. For instance, the server computing system can receive a class set from each client computing system that includes a class set including positive classes at that client and negative classes sampled by that client. The server computing system can be unable to discern the positive classes from the negative classes, such that the server cannot learn which classes are present at the client. For instance, the client class set can be anonymized such that the server computing system cannot discern the plurality of local positive class labels from the one or more negative class labels.

The server computing system can include a current version of a machine-learned global classification model configured to provide class labels associated with a plurality of candidate classes. For instance, the global classification model can output class labels for at least the classes at all of the client devices. The global classification model can represent an overall objective (e.g., an overall SoftMax objective) that is trained by the use of a plurality of reduced-size submodels at client devices.

The method (700) can include, at (704), communicating data descriptive of a respective classification submodel to each client computing system of the one or more client computing systems, wherein the respective classification submodel is configured to provide a classification output limited to the client class set received from the client computing system. For instance, the classification submodel can be a reduced version of the global classification model. A client computing system can then receive the data descriptive of a classification submodel, the classification submodel configured to provide a classification output limited to classes of the client class set.

The method (700) can include, at (706), receiving one or more model updates from the one or more client computing systems. For instance, the client computing system can communicate the model update to the server computing system, wherein the current version of the machine-learned global classification model is updated based at least in part on the model update. For instance, the server computing system can receive model updates from some or all of the client computing systems that are selected for a given learning round. The method (700) can then include, at (708), aggregating the one or more model updates to produce an aggregate model update. For instance, the server computing system can sum the one or more model updates to produce the aggregate model update. The method (700) can then include, at (710), updating the machine-learned global classification model based at least in part on the aggregate model update. This can be repeated until the global classification model is sufficiently trained (e.g., converges to near-optimal parameters).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for federated learning of a machine-learned model with reduced computing resource usage, the method comprising:
sampling, at a client computing system comprising one or more computing devices, one or more negative class labels from a negative sampling distribution, wherein the client computing system comprises a local training dataset, the local training dataset comprising a plurality of training examples each associated with one of a plurality of local positive class labels;
communicating, by the client computing system, a client class set comprising a union of the one or more negative class labels with the plurality of local positive class labels to a server computing system, the server computing system comprising a current version of a machine-learned global classification model configured to provide class labels associated with a plurality of candidate classes;
receiving, by the client computing system, data descriptive of a classification submodel, the classification submodel configured to provide a classification output limited to classes of the client class set;
determining, by the client computing system, a model update based at least in part on a sampled SoftMax loss, the sampled SoftMax loss determined based at least in part on use of the classification submodel with the local training dataset at the client computing system; and
communicating, by the client computing system, the model update to the server computing system, wherein the current version of the machine-learned global classification model is updated based at least in part on the model update.

2. The computer-implemented method of claim 1, wherein the negative sampling distribution comprises a uniform distribution over the plurality of candidate classes not included in the plurality of local positive class labels.

3. The computer-implemented method of claim 1, wherein the client class set is anonymized such that the server computing system cannot discern the plurality of local positive class labels from the one or more negative class labels.

4. The computer-implemented method of claim 1, wherein the global classification model comprises a feature extractor and a classifier model.

5. The computer-implemented method of claim 4, wherein the classification submodel comprises the feature extractor.

6. The computer-implemented method of claim 4, wherein the classifier model comprises a classifier weight matrix comprising class representations for the plurality of classes.

7. The computer-implemented method of claim 6, wherein the classification submodel comprises a sub classifier model comprising a sub classifier weight matrix, the sub classifier weight matrix comprising class representations only for classes in the client class set.

8. The computer-implemented method of claim 4, wherein the feature extractor comprises a neural network.

9. The computer-implemented method of claim 1, wherein the local training dataset comprises image data.

10. The computer-implemented method of claim 1, wherein the sampled SoftMax loss comprises a sum of an adjusted logit for a true class label and a logarithm of a sum of the exponents of adjusted logits for all classes in the client class set.

11. The computer-implemented method of claim 9, wherein the adjusted logits comprise the sum of a full SoftMax logit and the logarithm of a number of negative classes multiplied by a sampling probability.

12. The computer-implemented method of claim 1, wherein the client computing system comprises a mobile device.

13. A computer-implemented method for federated learning of a machine-learned model with reduced computing resource usage, the method comprising:
receiving, by a server computing system comprising one or more computing devices, one or more class sets from one or more client computing systems, the one or more class sets comprising, for each client computing system of the one or more client computing systems, a plurality of local positive class labels respective to a plurality of training examples of a local training dataset at the client computing system and one or more negative class labels sampled by the client computing system;
communicating, by the server computing system, data descriptive of a respective classification submodel to each client computing system of the one or more client computing systems, wherein the respective classification submodel is configured to provide a classification output limited to the client class set received from the client computing system;
receiving, by the server computing system, one or more model updates from the one or more client computing systems;
aggregating, by the server computing system, the one or more model updates to produce an aggregate model update; and
updating, by the server computing system, a machine-learned global classification model based at least in part on the aggregate model update.

14. The computer-implemented method of claim 13, wherein the respective classification submodel comprises a feature extractor.

15. The computer-implemented method of claim 14, wherein the global classification model comprises the feature extractor.

16. The computer-implemented method of claim 14, wherein the global classifier model comprises a classifier weight matrix comprising class representations for the plurality of classes.

17. The computer-implemented method of claim 16, wherein the respective classification submodel comprises a sub classifier model comprising a sub classifier weight matrix, the sub classifier weight matrix comprising class representations only for classes in the client class set of a respective client computing system.

18. The computer-implemented method of claim 14, wherein the feature extractor comprises a neural network.

19. The computer-implemented method of claim 13, wherein the one or more model updates are determined with respect to a sampled SoftMax loss, wherein the sampled SoftMax loss comprises a sum of an adjusted logit for a true class label and a logarithm of a sum of the exponents of adjusted logits for all classes in the client class set of a respective client computing system.

20. The computer-implemented method of claim 19, wherein the adjusted logits comprise the sum of a full SoftMax logit and the logarithm of a number of negative classes multiplied by a sampling probability.
